(19) United States
(12) Patent Application Publication
(10) Pub. No.: US 2010/0255405 A1
(43) Pub. Date: Oct. 7, 2010

(54) DIRECT METHANOL FUEL CELL

(76) Inventors: Hiroaki Matsuda, Osaka (JP); Hideyuki Ueda, Osaka (JP)

Correspondence Address: MCDERMOTT WILL & EMERY LLP, 600 13TH STREET, NW, WASHINGTON, DC, 20005-3096, US

(21) Appl. No.: 12/753,531

(22) Filed: Apr. 2, 2010

(30) Foreign Application Priority Data
Apr. 3, 2009 (JP) 2009-091014

(51) Int. Cl. H01M 8/10

(52) U.S. Cl. 429/483

(57) ABSTRACT

A direct methanol fuel cell has at least one cell including a membrane electrode assembly. The membrane electrode assembly includes an anode, a cathode, and a polymer electrolyte membrane disposed between the anode and the cathode. The cathode includes a cathode catalyst layer in contact with the polymer electrolyte membrane, and a cathode diffusion layer in contact with the cathode catalyst layer. The cathode catalyst layer includes a cathode catalyst, a catalyst support on which the cathode catalyst is supported, and a polymer electrolyte. The weight ratio of the polymer electrolyte to the catalyst support is from 0.2 to 0.55. The cathode catalyst layer in a dry state has a porosity of 50% to 85%.

### FIELD OF THE INVENTION

The invention relates to direct methanol fuel cells, and more particularly, to a direct methanol fuel cell whose cathode catalyst layer is optimized.

### BACKGROUND OF THE INVENTION

It is desired to put solid polymer fuel cells using polymer electrolyte membranes into practical use as early as possible as the power source for households, electric vehicles, and mobile devices such as cell phones and notebook personal computers.

A solid polymer fuel cell (hereinafter referred to as simply a “fuel cell”) has at least one cell which includes, for example, a membrane electrode assembly (hereinafter referred to as an “MEA”) and a pair of separators. The MEA includes a polymer electrolyte membrane, an anode, and a cathode. The anode and the cathode each have a catalyst layer and a diffusion layer. The anode is bonded to one face of the polymer electrolyte membrane in the thickness direction, while the cathode is bonded to the other face of the polymer electrolyte membrane. The pair of separators is disposed so as to sandwich the two opposite faces of the MEA in the thickness direction. Fuel cells generate power by supplying a fuel containing hydrogen gas to the anode and supplying an oxidant such as air to the cathode. Direct methanol fuel cells, which supply methanol directly to the anode as the fuel, are particularly suited for the reduction of size and weight, thus being developed as the power source for mobile devices.

However, practical utilization of direct methanol fuel cells has some problems to be solved, one of which is long-term life characteristics. The output of direct methanol fuel cells gradually decreases with increasing power generation time. Direct methanol fuel cells are required to maintain the predetermined output for a total of 40000 hours or more when used as the power source for households, and for a total of 5000 hours or more when used as the power source for mobile devices. However, such life characteristics have not been achieved so far.

The output decrease is attributed to several factors, one of which is deterioration of oxidant diffusibility at the cathode. As power is generated, water is produced at the cathode by the electrode reaction. In addition, the methanol aqueous solution supplied to the anode migrates to the cathode through the polymer electrolyte membrane, which is known as methanol crossover (hereinafter referred to as “MCO”). The migration of water to the cathode directly leads to an increase of water at the cathode. Also, when methanol migrates to the cathode and is oxidized there, carbon dioxide and water are produced. Due to these phenomena, water tends to accumulate at the cathode during power generation. If the water accumulated at the cathode during power generation is not sufficiently removed, it can impair the oxidant diffusion at the cathode.

It has been found that the output decrease caused by impaired oxidant diffusion at the cathode is more evident as the concentration of the methanol aqueous solution supplied to the anode becomes higher. This is probably because the higher the concentration of the methanol aqueous solution is, the more MCO occurs, and the more water accumulates at the cathode.

Due to the above reason, it is common in direct methanol fuel cells to set the concentration of the methanol aqueous solution supplied to the anode to approximately 1 mol/L. Such concentration does not cause so much MCO, thereby making it relatively easy to suppress the output decrease in long-term operation.

However, the higher the concentration of the methanol aqueous solution supplied to the anode is, the more compact, light-weight, and efficient the fuel cell system can become. Specifically, since less water is necessary for diluting methanol, the volume of the fuel cartridge or the fuel tank in the fuel cell system can be decreased. Further, when a fuel supply pump is used to supply the fuel to the anode, the flow rate of the fuel supplied by the pump can be lowered. This allows a reduction in the power consumed by the pump and therefore an increase in the output of the fuel cell system. Hence, when the fuel cell is used as the power source for a mobile device, it is greatly advantageous to make the concentration of the methanol aqueous solution (fuel) high. Therefore, various techniques for suppressing MCO when using high concentration methanol aqueous solutions have been proposed.

For example, it has been proposed to use a polymer electrolyte membrane with low methanol permeability, or reduce the porosity of the anode diffusion layer to decrease the methanol permeability of the anode diffusion layer.

Further, U.S. Patent Publication No. 2008/0206616 (Document 1) discloses a catalyst layer for a direct methanol fuel cell in which the concentration of polymer electrolyte is changed in the direction parallel to the main surface of the electrolyte membrane and/or the direction perpendicular to the main surface. Document 1 recites that the concentrations of various components of the catalyst layer are changed as a means for improving methanol diffusion and achieving a sufficient loading amount of catalyst without sacrificing electronic conductivity.

For example, Japanese Laid-Open Patent Publication No. Hei 9-213350 (Document 2) and Japanese Laid-Open Patent Publication No. 2002-075403 (Document 3), which are directed to fuel cells using hydrogen as the fuel, not direct methanol fuel cells, propose techniques of limiting the weight ratio between the catalyst support and the polymer electrolyte contained in the cathode catalyst layer, in order to improve power generation performance.

### BRIEF SUMMARY OF THE INVENTION

The inventors have diligently studied the configuration of the cathode catalyst layer for direct methanol fuel cells. As a result, they have found that when the weight ratio between the catalyst support and the polymer electrolyte and the porosity of the cathode catalyst layer are set in a specific range, the cathode catalyst layer has a good balance between proton conductivity, oxidant diffusibility, and water removal ability. Based on this finding, the invention has been completed.

That is, in one aspect of the invention, the direct methanol fuel cell has at least one cell including a membrane electrode assembly. The membrane electrode assembly includes an anode, a cathode, and a polymer electrolyte membrane disposed between the anode and the cathode. The cathode includes a cathode catalyst layer in contact with the polymer electrolyte membrane, and a cathode diffusion layer in contact with the cathode catalyst layer. The cathode catalyst layer includes a cathode catalyst, a catalyst support on which the cathode catalyst is supported, and a polymer electrolyte. The weight ratio of the polymer electrolyte to the catalyst support is from 0.2 to 0.55. The cathode catalyst layer in a dry state has a porosity of 50% to 85%. The weight ratio of the polymer electrolyte to the catalyst support is preferably from 0.3 to 0.5. The cathode catalyst layer in a dry state preferably has a porosity of 60% to 80%. The direct methanol fuel cell of the invention uses methanol or a methanol aqueous solution with a methanol concentration of 3 mol/L or more as the fuel.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a block diagram schematically showing a direct methanol fuel cell according to one embodiment of the invention; and

FIG. 2 is a block diagram schematically showing a direct methanol fuel cell according to another embodiment of the invention.

### DETAILED DESCRIPTION OF THE INVENTION

According to conventional techniques, it is difficult to provide direct methanol fuel cells with required long-term life characteristics. This is probably because the suppression of MCO is insufficient, although the detailed reasons are not yet clear. Thus, the present inventors have examined phenomena occurring due to MCO at the cathodes of direct methanol fuel cells using a high concentration methanol aqueous solution as the fuel.

Before and after shut-down and during the suspension of operation, methanol having migrated to the cathode may remain at the cathode without being oxidized, unlike during power generation in which air is supplied to the cathode. The methanol remaining at the cathode is thought to swell the polymer electrolyte of the cathode catalyst layer. It is known that as the concentration of the methanol aqueous solution becomes higher, the amount of MCO increases and the expansion rate of the polymer electrolyte increases significantly. That is, when a high concentration methanol aqueous solution is used as the fuel, MCO cannot be suppressed completely, and therefore, the polymer electrolyte of the cathode catalyst layer may swell significantly. In this case, due to a decrease in the pores of the cathode catalyst layer, both water removal ability and oxidant diffusibility may lower.

However, if air is supplied to the cathode for power generation, the expansion rate of the polymer electrolyte of the cathode catalyst layer having swollen significantly due to MCO should decrease since the methanol is decomposed to water through oxidation reaction. In reality, however, it has been found that as the concentration of the methanol aqueous solution used as the fuel becomes higher, the output deterioration in long-term operation increases. That is, it appears that the output deterioration in long-term operation is affected by MCO.

The examination of the above phenomena indicates that when a high concentration methanol aqueous solution is used as the fuel, the polymer electrolyte of the cathode catalyst layer swells significantly to cause a decrease in oxidant diffusibility due to a factor different from those when a common methanol aqueous solution of approximately 1 mol/L is used as the fuel, although the details are still being examined.

In view of the problem as described above, an object of the invention is to provide a direct methanol fuel cell having excellent long-term life characteristics even when using a high concentration methanol aqueous solution as the fuel.

In one aspect of the invention, the direct methanol fuel cell has at least one cell including a membrane electrode assembly. The membrane electrode assembly includes an anode, a cathode, and a polymer electrolyte membrane disposed between the anode and the cathode. The cathode includes a cathode catalyst layer in contact with the polymer electrolyte membrane, and a cathode diffusion layer in contact with the cathode catalyst layer. The cathode catalyst layer includes a cathode catalyst, a catalyst support on which the cathode catalyst is supported, and a polymer electrolyte. The weight ratio of the polymer electrolyte to the catalyst support is from 0.2 to 0.55. The cathode catalyst layer in a dry state has a porosity of 50% to 85%. The direct methanol fuel cell of the invention uses methanol or a methanol aqueous solution with a methanol concentration of 3 mol/L or more as the fuel.

This direct methanol fuel cell is characterized by the cathode catalyst layer. Thus, except for the cathode catalyst layer, the same configuration as that of conventional direct methanol fuel cells can be employed.

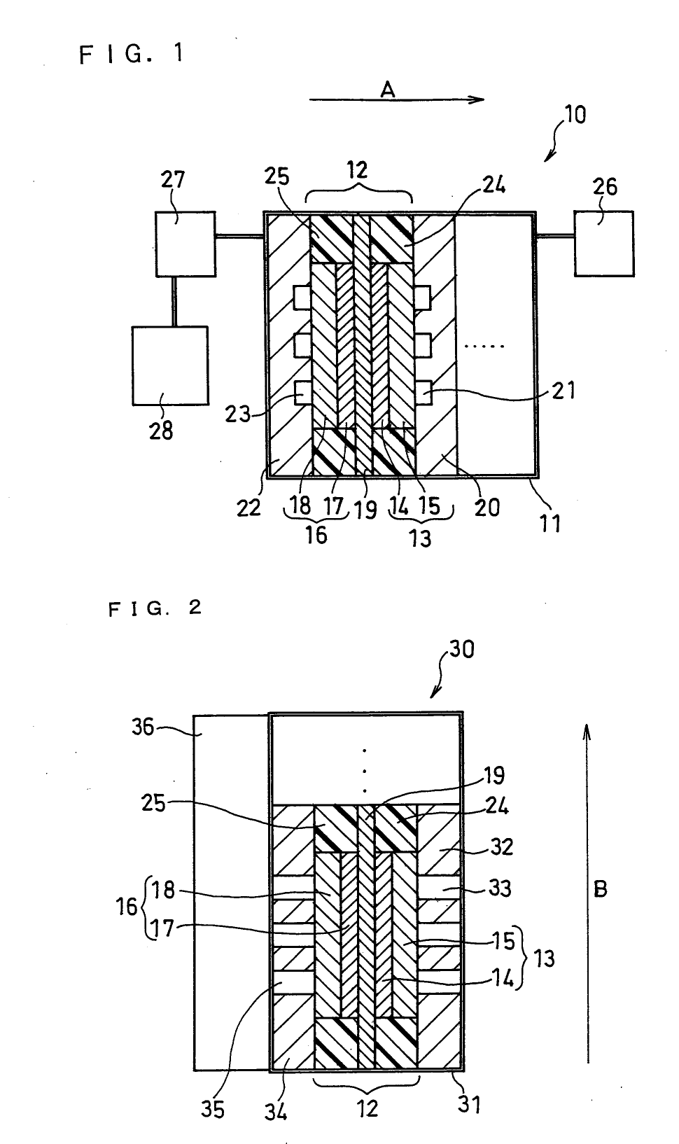

FIG. 1 is a block diagram schematically showing a direct methanol fuel cell according to one embodiment of the invention. FIG. 2 is a block diagram schematically showing a direct methanol fuel cell according to another embodiment of the invention.

A fuel cell 10 of FIG. 1 includes a fuel cell stack 11 containing at least one cell 12, an oxidant supply pump 26, a fuel supply pump 27, and a fuel tank 28. The fuel tank 28 contains methanol or a methanol aqueous solution with a methanol concentration of 3 mol/L or more.

The cell 12 has a membrane electrode assembly (MEA) including a cathode 13, an anode 16, and a polymer electrolyte membrane 19 disposed therebetween. As illustrated in FIG. 1, the cell 12 may be sandwiched between a cathode separator 20 and an anode separator 22 so that the cathode separator 20 contacts the cathode 13 while the anode separator 22 contacts the anode 16. The cathode separator 20 is disposed so as to contact the other face of the cathode 13 from the face in contact with the polymer electrolyte membrane 19. The face of the cathode separator 20 in contact with the cathode 13 has an oxidant flow channel 21. The anode separator 22 is disposed so as to contact the other face of the anode 16 from the face in contact with the polymer electrolyte membrane 19. The face of the anode separator 22 in contact with the anode 16 has a fuel flow channel 23.

FIG. 1 shows only one cell 12. When the fuel cell stack 11 includes a plurality of cells 12, the respective cells 12 are disposed in the direction parallel to the stacking direction of the cathode 13, the polymer electrolyte membrane 19, and the anode 16 (the direction parallel to the arrow A). The cells 12 are connected in series.

The cathode 13 has a cathode catalyst layer 14 in contact with one face of the polymer electrolyte membrane 19 in the thickness direction, and a cathode diffusion layer 15 in contact with the cathode separator 20. The anode 16 has an anode catalyst layer 17 in contact with the other face of the polymer electrolyte membrane 19, and an anode diffusion layer 18 in contact with the anode separator 22. Gaskets 24 and 25 are disposed around the cathode 13 and the anode 16, respectively.

The polymer electrolyte membrane 19 can be made of a material commonly used in the field of fuel cells. Examples of such materials include perfluorocarbon sulfonic acid polymer membranes and hydrocarbon polymer membranes. Also, commercially available polymer electrolyte membranes for fuel cells may also be used. Examples of commercially available products include Nafion® (available from E.I. Dupont de Nemours and Company) and Flemion® (available from Asahi Glass Co., Ltd.).

The cathode catalyst layer 14 includes a cathode catalyst, a catalyst support on which the cathode catalyst is supported, and a polymer electrolyte. The cathode catalyst can be a material having the function of reducing oxygen. Usable examples of the cathode catalyst include noble metals such as Pt. Pt may be in the form of an alloy containing, for example, Co or Au.

The catalyst support can be an electron conductive material, and examples include carbon materials and conductive ceramics. Among them, carbon materials are preferable due to their high conductivity, stability, and the like. Examples of carbon materials include carbon black and carbon nanofibers.

The polymer electrolyte can be a proton conductive material, and usable examples include perfluorocarbon sulfonic acid polymers (e.g., Nafion® and Flemion®) and hydrocarbon polymers. The polymer electrolyte contained in the cathode catalyst layer 14 may be the same as or different from the material constituting the polymer electrolyte membrane 19.

The cathode diffusion layer 15 can be a material commonly used in the field of fuel cells. The cathode diffusion layer 15 can be made of, for example, carbon non-woven fabric, carbon paper, carbon cloth, or carbon felt. These materials may contain a water-repellent material in order to improve water removal ability. Usable examples of water-repellent materials include fluorocarbon resins such as polytetrafluoroethylene (PTFE) and tetrafluoroethylene-hexafluoropropylene copolymer (FEP).

Further, the face of the cathode diffusion layer 15 in contact with the cathode catalyst layer 14 may be provided with a water-repellent microporous layer. The water-repellent microporous layer may contain, for example, a carbon material and fluorocarbon resin.

The configurations of the anode catalyst layer 17 and the anode diffusion layer 18 may be the same as those of the cathode catalyst layer 14 and the cathode diffusion layer 15 except that the anode catalyst layer 17 contains an anode catalyst. The anode catalyst contained in the anode catalyst layer 17 can be a material having the function of oxidizing methanol. Examples of such materials include a Pt—Ru alloy.

The cathode separator 20 and the anode separator 22 can be made of a material having electronic conductivity and strength. In particular, in terms of stability or the like, a carbon material is preferable as the material constituting the cathode separator 20 and the anode separator 22.

In the fuel cell 10 of FIG. 1, an oxidant such as air is supplied to the cathode 13 by the oxidant supply pump 26, while the methanol or methanol aqueous solution of 3 mol/L or more contained in the fuel tank 28 is supplied to the anode 16 by the fuel supply pump 27, in order to generate power.

When a plurality of cells 12 are included, the fuel cell stack 11 preferably has a stack structure in which the plurality of cells 12, each sandwiched between a pair of separators 20 and 22, are stacked.

In the invention, the weight ratio of the polymer electrolyte to the catalyst support in the cathode catalyst layer 14 is set in the range from 0.2 to 0.55. This ratio of from 0.2 to 0.55 permits a significant improvement in the long-term life characteristics of direct methanol fuel cells using methanol or a methanol aqueous solution of 3 mol/L or more as the fuel.

When the ratio is lower than 0.2, the polymer electrolyte becomes insufficient, and thus the proton conductive paths in the cathode catalyst layer 14 become insufficient. As a result, the output decreases. When the ratio is higher than 0.55, the amount of the polymer electrolyte contained in the cathode catalyst layer 14 becomes excessive. Hence, the polymer electrolyte swells significantly due to MCO, and thus the pores in the cathode catalyst layer 14 become insufficient. As a result, oxidant diffusion is impaired, and long-term life characteristics deteriorate. The ratio is more preferably from 0.3 to 0.5.

Further, the porosity of the cathode catalyst layer 14 in a dry state is 50% to 85%. The porosity of the cathode catalyst layer 14 in a dry state is preferably 60 to 80%, and more preferably 65% to 80%.

As used herein, porosity refers to the ratio of pores to the apparent volume, and can be calculated from, for example, the apparent thickness of the cathode catalyst layer, the weight of the cathode catalyst layer per unit area, and the true densities of the materials. Also, the porosity of the cathode catalyst layer can be measured, for example, by mercury intrusion. The dry state as used herein refers to the state of the cathode catalyst layer which has been dried at a temperature of 50° C. and a humidity of 10% for 12 hours.

The apparent thickness of the cathode catalyst layer can be determined, for example, by observing a longitudinal cross-sectional of the cathode catalyst layer with a scanning electron microscope, measuring the thickness of the cathode catalyst layer at several locations, and averaging the measured values.

The weight of the cathode catalyst layer per unit area refers to the value obtained by dividing the weight of a predetermined region of the cathode catalyst layer by the area (projected area) of the predetermined region calculated from the shape of the contour thereof seen from the direction of the normal to the main surface thereof.

When the porosity of the cathode catalyst layer 14 is lower than 50%, even if the weight ratio of the polymer electrolyte to the catalyst support is set in the range from 0.2 to 0.55, the pores in the cathode catalyst layer 14 become insufficient.

When the porosity of the cathode catalyst layer 14 is higher than 85%, if the weight ratio of the polymer electrolyte to the catalyst support is set in the range from 0.2 to 0.55, the proton conductivity in the cathode catalyst layer 14 becomes insufficient.

In direct methanol fuel cells using a methanol aqueous solution of approximately 1 mol/L as the fuel and fuel cells using hydrogen as the fuel, it is common to set the weight ratio of the polymer electrolyte to the catalyst support in the cathode catalyst layer to from approximately 0.8 to 1.2. On the other hand, in the direct methanol fuel cell of the invention, the weight ratio of the polymer electrolyte to the catalyst support is set to from 0.2 to 0.55, which is significantly small compared with conventional ratios. Further, the porosity of the cathode catalyst layer in a dry state is set to 50% to 85%. Therefore, in the direct methanol fuel cell of the invention which uses a high concentration methanol aqueous solution of 3 mol/L or more as the fuel, even if the polymer electrolyte in the cathode catalyst layer swells significantly due to MCO, it is possible to secure sufficient pores in the cathode catalyst layer. This allows the cathode catalyst layer 14 to have good balance between proton conductivity, oxidant diffusibility, and water removal ability. Therefore, the invention can improve the long-term life characteristics of the direct methanol fuel cell significantly.

The porosity of the cathode catalyst layer 14 can be suitably adjusted, for example, by compressing the formed cathode catalyst layer 14 by hot pressing or the like. Further, the porosity of the cathode catalyst layer 14 can also be adjusted suitably by changing the conditions for producing the cathode catalyst layer 14. For example, the porosity can be controlled by adjusting the viscosity of the cathode catalyst ink and the temperature for drying the ink.

The thickness of the cathode catalyst layer 14 is preferably 10 to 100 μm. When the thickness of the cathode catalyst layer 14 is less than 10 μm, it may be difficult to form a catalyst layer evenly over the whole area of the cathode. When the thickness of the cathode catalyst layer 14 is greater than 100 μm, the oxidant has to travel for a long distance in the cathode catalyst layer 14. Thus, the oxidant diffusibility in the cathode catalyst layer 14 may lower.

The amount of the polymer electrolyte contained in the cathode catalyst layer 14 is preferably 0.1 to 1.0 mg/cm².

As used herein, the amount of the polymer electrolyte refers to the value obtained by dividing the amount of the polymer electrolyte contained in a predetermined region by the area (projected area) of the predetermined region calculated from the shape of the contour thereof seen from the direction of the normal to the main surface thereof.

A fuel cell 30 of FIG. 2 is the same as the fuel cell 10 of FIG. 1 except that the methods for supplying the fuel and oxidant are mainly different. In FIG. 2, the same components as those of FIG. 1 are given the same numbers.

The fuel cell 30 of FIG. 2 includes a fuel cell stack 31 having at least one cell 12, and a fuel tank 36. In the fuel cell 30, the cell 12 is sandwiched between a pair of current collector plates 32 and 34 instead of a pair of separators. The cathode current collector plate 32 is in contact with the cathode diffusion layer 15 of the cathode 13, while the anode current collector plate 34 is in contact with the anode diffusion layer 18 of the anode 16.

The part of the cathode current collector plate 32 in contact with the cathode diffusion layer 14 has oxidant slits (through-holes) 33 which are distributed over the whole area and penetrate through the thickness of the cathode current collector plate 32. For example, an oxidant such as air is supplied to the cathode 13 through the oxidant slits 33 by natural diffusion.

The end face of the fuel cell stack 31 on the anode current collector plate 34 side is equipped with the fuel tank 36. The part of the anode current collector plate 34 in contact with the anode diffusion layer 18 has fuel slits (through-holes) 35 which are distributed over the whole area. The fuel is supplied to the anode 16 through the fuel slits 35 by natural diffusion. That is, the fuel cell 30 of FIG. 2 supplies the oxidant to the cathode 13 and the fuel to the anode 16 by natural diffusion without using any pumps.

Also, when the fuel cell 30 of FIG. 2 includes a plurality of cells 12, the cells 12 are disposed in the height direction of the cells 12 (direction parallel to the arrow B). In this case, each of the cells 12 is also sandwiched between the cathode current collector plate 32 with slits and the anode current collector plate 34 with slits. In the fuel cell 30 of FIG. 2, the cells 12 are also connected in series.

The fuel cell 30 of FIG. 2 also uses methanol or a methanol aqueous solution of 3 mol/L or more as the fuel. In the cathode catalyst layer 14, the weight ratio of the polymer electrolyte to the catalyst support is from 0.2 to 0.55. The ratio is preferably from 0.3 to 0.5. Also, the porosity of the cathode catalyst layer 14 in a dry state is 50% to 85%. The porosity is preferably 60 to 80%, and more preferably 65% to 80%.

Also, the catalyst support contained in the cathode catalyst layer 14 is preferably a carbon material such as carbon black or carbon nanofibers, as described above.

The direct methanol fuel cell according to one embodiment of the invention is preferably equipped with the fuel supply pump 27 for supplying the fuel to the anode 16 and the oxidant supply pump 26 for supplying the oxidant to the cathode 13, as illustrated in FIG. 1. When these supply pumps 26 and 27 are not used, it is difficult, for example, to control the amount of fuel supplied to the anode 16 and the amount of oxidant to the cathode 13. Thus, the decrease in the oxidant diffusibility in the cathode catalyst layer 14 due to MCO may not be sufficiently suppressed. It should be noted, however, that even when the supply pumps 26 and 27 are not used as shown in FIG. 2, the long-term life characteristics can be sufficiently improved, compared with conventional direct methanol fuel cells.

The fuel cell stack 11 of FIG. 1 may further include current collector plates, insulator plates, end plates, heaters, etc. which are stacked outside the outermost separators 20 and 22. Likewise, the fuel cell stack 31 of FIG. 2 may further include insulator plates, end plates, heaters, etc. which are stacked outside the current collector plates 32 and 34. In this case, the insulator plates, end plates, heaters, etc. stacked outside the current collector plates 32 and 34 preferably have slits (through-holes) or flow channels communicating with the slits 33 and 35.

The cathode catalyst layer 14 can be prepared, for example, as follows. A cathode catalyst ink is prepared by dispersing a cathode catalyst supported on a catalyst support and a predetermined polymer electrolyte in a predetermined dispersion medium. The weight ratio of the polymer electrolyte to the catalyst support in the cathode catalyst ink is from 0.2 to 0.55. The cathode catalyst ink is then applied onto a predetermined substrate and dried to obtain the cathode catalyst layer 14. In this case, the cathode catalyst layer 14 can be transferred to the polymer electrolyte membrane 19, for example, by hot pressing.

Alternatively, the cathode catalyst ink may be applied onto the polymer electrolyte membrane 19 and dried to form the cathode catalyst layer 14. According to this method, the cathode catalyst layer 14 can be formed directly on the polymer electrolyte membrane 19.

The amount of polymer electrolyte contained in the cathode catalyst layer 14 can be measured, for example, as follows. A predetermined part of the cathode catalyst layer 14 containing a predetermined polymer electrolyte (e.g., perfluorocarbon sulfonic acid polymer), a cathode catalyst, and a catalyst support with the cathode catalyst supported thereon, which is formed on the polymer electrolyte membrane 19, is scraped off. The weight of the scraped sample is measured with a microbalance. Subsequently, the sample is burned, using an automatic combustor (e.g., AQF-100 available from Mitsubishi Chemical Corporation), and the gas produced is allowed to be absorbed by a liquid absorbent. The amount of F ions contained in the liquid absorbent is measured with an ion chromatograph (e.g., ICS-1500 available from Dionex). From the amount of F ions, the amount of polymer electrolyte contained in the predetermined part of the cathode catalyst layer 14 can be determined. Using the determined value, the amount of polymer electrolyte contained in the predetermined part of the cathode catalyst layer 14 per 1 cm² can be obtained.

The amount of cathode catalyst contained in the cathode catalyst layer 14 can be measured, for example, as follows. In the same manner as described above, a predetermined part of the cathode catalyst layer 14 containing a predetermined polymer electrolyte (e.g., perfluorocarbon sulfonic acid polymer), a cathode catalyst, and a catalyst support with the cathode catalyst supported thereon, which is formed on the polymer electrolyte membrane 19, is scraped off. The weight of the scraped sample is measured with a microbalance. The sample is then dissolved in aqua regia to filtrate undissolved matter. The resultant filtrate is mixed with water to form a solution of predetermined amount (e.g., 100 ml). The amount of cathode catalyst contained in the solution of predetermined amount is measured with an inductively coupled plasma-atomic emission spectrometer (ICP-AES; e.g., iCAP 6300 available from Thermo Fisher Scientific Inc.). Using the measured value, the amount of cathode catalyst contained in the predetermined part of the cathode catalyst layer 14 per 1 cm² can be determined.

The amount of conductive carbon particles contained in the predetermined part of the cathode catalyst layer 14 per 1 cm² can be obtained, for example, by subtracting the amounts of polymer electrolyte and cathode catalyst per 1 cm² from the weight of the predetermined part of the cathode catalyst layer 14 per 1 cm².

The weight ratio of the polymer electrolyte to the catalyst support can be obtained from the amounts of catalyst support and polymer electrolyte obtained in the above manner.

### EXAMPLES

The invention is hereinafter described specifically by way of Examples, but the invention is not to be construed as being limited to the following Examples.

### Example 1

### Preparation of Catalyst Layer

A Pt catalyst was used as the cathode catalyst. The Pt catalyst was supported on carbon black (trade name: ketjen black ECP, available from Ketjen black International Company Ltd.) serving as the catalyst support. The weight ratio of the PT catalyst to the total of the Pt catalyst and carbon black was set to 50% by weight.

The Pt catalyst supported on the catalyst support was dispersed in an isopropanol aqueous solution to form a dispersion (6 ml), and this dispersion was mixed with a dispersion of a polymer electrolyte (trade name: Nafion®, 5 wt % solution, available from Sigma-Aldrich Japan)(5 ml) to prepare a cathode catalyst ink. In the cathode catalyst ink, the weight ratio of the polymer electrolyte to the catalyst support was set to 0.2.

This cathode catalyst ink was applied onto a polytetrafluoroethylene (PTFE) sheet with a doctor blade, and dried at 80° C. to form a cathode catalyst layer.

An anode catalyst layer was prepared in the same manner as the cathode catalyst layer, except for the use of a Pt—Ru catalyst (Pt:Ru=1:1 (atomic ratio)) as the anode catalyst and the use of ketjen black (ECP) as the catalyst support on which the anode catalyst is supported. The weight ratio of the Pt—Ru catalyst to the total of the Pt—Ru catalyst and ketjen black was set to 50% by weight.

### [Preparation of Diffusion Layer]

Acetylene black (trade name: DENKA BLACK, available from Denki Kagaku Kogyo K.K.) and a PTFE dispersion (reagent, solid content 60% by weight, available from Sigma-Aldrich Japan) were dispersed in ion-exchange water, to prepare an ink for forming a water-repellent layer. The ink was applied onto one side of carbon paper (trade name: AvCarb® 1071HCB, available from Ballard Material Products Inc.) and dried to form a water-repellent layer. In this way, a cathode diffusion layer was prepared.

An anode diffusion layer was prepared in the same manner as the cathode diffusion layer, except that the carbon paper was changed to TGP-H-090 (trade name) of Toray Industries Inc.

### [Production of MEA and Cell]

The cathode catalyst layer was laminated on one face of a polymer electrolyte membrane (trade name: Nafion®112, available from E.I. Dupont de Nemours and Company), while the anode catalyst layer was laminated on the other face. At this time, the other face of the cathode catalyst layer from the face in contact with the PTFE sheet and the other face of the anode catalyst layer from the face in contact with the PTFE sheet were brought into contact with the polymer electrolyte membrane.

The resultant laminate was hot pressed, and the PTFE sheet was then peeled from the cathode catalyst layer and the anode catalyst layer to transfer the cathode catalyst layer and the anode catalyst layer onto the polymer electrolyte membrane.

Next, the cathode diffusion layer was laminated on the cathode catalyst layer, while the anode diffusion layer was laminated on the anode catalyst layer. At this time, the catalyst layer and the diffusion layer were laminated so that the water-repellent layer formed on the diffusion layer contacted the catalyst layer. These catalyst layers and diffusion layers were bonded by hot pressing to form a membrane electrode assembly (MEA). The porosity of the cathode catalyst layer included in the MEA was 75%.

The porosity of the cathode catalyst layer was calculated from the apparent thickness of the cathode catalyst layer, the weight of the cathode catalyst layer per unit area, and the true densities of the materials.

A direct methanol fuel cell as illustrated in FIG. 1 was produced.

First, the MEA was fitted with gaskets. Specifically, a rubber gasket was fitted to the part of each side of the polymer electrolyte membrane having no electrode (catalyst layer+diffusion layer). The MEA fitted with the gaskets was then sandwiched between a pair of graphite separators, current collector plates, rubber heaters, insulator plates, and end plates in this order for lamination. Thereafter, a thermocouple was attached to each separator. In this way, a cell was produced.

An air pump was connected to the cell with a pipe. Further, a fuel pump and a fuel tank were connected thereto with another pipe. In this way, a direct methanol fuel cell as illustrated in FIG. 1 was produced. This direct methanol fuel cell was named a fuel cell 1. This fuel cell was connected with an external load for consuming power generated by the cell. An electronic load unit was used as the external load.

### [Evaluation]

The direct methanol fuel cell 1 was subjected to the following evaluation test for long-term life characteristic. In the following evaluation, a 4 mol/L methanol aqueous solution was used as the fuel, while air was used as the oxidant.

First, a continuous power generation was performed at a constant current of 150 mA/cm² for 60 minutes. At this time, the cell temperature was maintained at 60° C., and the supply amounts of fuel and air were adjusted so that the air (oxidant) utilization rate was 50% and the fuel utilization rate was 70%. Thereafter, the power generation was suspended for 60 minutes. During the suspension of the power generation, the supply of air and fuel and the heating by the heaters were stopped. This cycle was repeated 500 times. The ratio of the average voltage at the 500^{th} cycle to the average voltage at the 1^{st} cycle was obtained. The obtained value was defined as voltage retention rate. Table 1 shows the results. In Table 1, the voltage retention rates are expressed as percentages.

### Example 2

A fuel cell 2 was produced in the same manner as in Example 1, except that the weight ratio of the polymer electrolyte to the catalyst support in the cathode catalyst layer was set to 0.3. The porosity of the cathode catalyst layer included in the MEA was 72%. The fuel cell 2 was subjected to the same evaluation test as, that of Example 1 to obtain voltage retention rate. Table 1 shows the results.

### Example 3

A fuel cell 3 was produced in the same manner as in Example 1, except that the weight ratio of the polymer electrolyte to the catalyst support in the cathode catalyst layer was set to 0.4. The porosity of the cathode catalyst layer included in the MEA was 69%. The fuel cell 3 was subjected to the same evaluation test as that of Example 1 to obtain voltage retention rate. Table 1 shows the results.

### Example 4

A fuel cell 4 was produced in the same manner as in Example 1, except that the weight ratio of the polymer electrolyte to the catalyst support in the cathode catalyst layer was set to 0.5. The porosity of the cathode catalyst layer included in the MEA was 66%. The fuel cell 4 was subjected to the same evaluation test as that of Example 1 to obtain voltage retention rate. Table 1 shows the results.

### Example 5

A fuel cell 5 was produced in the same manner as in Example 1, except that the weight ratio of the polymer electrolyte to the catalyst support in the cathode catalyst layer was set to 0.55. The porosity of the cathode catalyst layer included in the MEA was 64%. The fuel cell 5 was subjected to the same evaluation test as that of Example 1 to obtain voltage retention rate. Table 1 shows the results.

### Example 6

A fuel cell 6 was produced in the same manner as in Example 3, except that the catalyst support on which the cathode catalyst was supported was changed to carbon nanofibers (trade name: CNF-P, available from Jemco Co., Ltd.). The porosity of the cathode catalyst layer included in the MEA was 71%. The fuel cell 6 was subjected to the same evaluation test as that of Example 1 to obtain voltage retention rate. Table 1 shows the results.

### Example 7

A cathode catalyst layer was prepared in the same manner as in Example 1, and the cathode catalyst layer was compressed by hot pressing. Except for the use of this cathode catalyst layer, a fuel cell 7 was produced in the same manner as in Example 1. The porosity of the cathode catalyst layer included in the MEA was 50%. The fuel cell 7 was subjected to the same evaluation test as that of Example 1 to obtain voltage retention rate. Table 1 shows the results.

### Example 8

The cathode catalyst ink was applied onto a PTFE sheet in the same manner as in Example 1, and the ink was dried at 40° C. to form a cathode catalyst layer. Except for the use of this cathode catalyst layer, a fuel cell 8 was produced in the same manner as in Example 1. The porosity of the cathode catalyst layer included in the MEA was 85%. The fuel cell 8 was subjected to the same evaluation test as that of Example 1 to obtain voltage retention rate. Table 1 shows the results.

### Example 9

A direct methanol fuel cell as illustrated in FIG. 2 was produced.

First, an MEA was produced in the same manner as in Example 3. Subsequently, a rubber gasket was fitted to the part of each side of the polymer electrolyte membrane having no electrode (catalyst layer+diffusion layer). Thereafter, the MEA fitted with the gaskets was sandwiched between a pair of current collector plates with slits and end plates with slits in this order, to produce a cell. A fuel tank was attached to the anode side of the cell, to produce a direct methanol fuel cell as illustrated in FIG. 2. This direct methanol fuel cell was named a fuel cell 9. The fuel cell 9 was connected with an external load for consuming power generated by the cell. An electronic load unit was used as the external load.

### [Evaluation]

The fuel cell 9 produced in this example was subjected to the following evaluation test for long-term life characteristic. In the following evaluation, a 4 mol/L methanol aqueous solution was used as the fuel, while air was used as the oxidant.

First, a continuous power generation was performed at a constant current of 150 mA/cm² for 60 minutes. Thereafter, the power generation was suspended for 60 minutes. This cycle was repeated 500 times. The ratio of the average voltage at the 500^{th} cycle to the average voltage at the 1^{st} cycle was obtained. The obtained value was defined as voltage retention rate. Table 1 shows the results.

### Comparative Example 1

A comparative fuel cell 1 was produced in the same manner as in Example 1, except that the weight ratio of the polymer electrolyte to the catalyst support in the cathode catalyst layer was set to 0.15. The porosity of the cathode catalyst layer included in the MEA was 77%. The comparative fuel cell 1 was subjected to the same evaluation test as that of Example 1 to obtain voltage retention rate. Table 1 shows the results.

### Comparative Example 2

A comparative fuel cell 2 was produced in the same manner as in Example 1, except that the weight ratio of the polymer electrolyte to the catalyst support in the cathode catalyst layer was set to 0.6. The porosity of the cathode catalyst layer included in the MEA was 62%. The comparative fuel cell 2 was subjected to the same evaluation test as that of Example 1 to obtain voltage retention rate. Table 1 shows the results.

### Comparative Example 3

A comparative fuel cell 3 was produced in the same manner as in Example 1, except that the weight ratio of the polymer electrolyte to the catalyst support in the cathode catalyst layer was set to 1.0. The porosity of the cathode catalyst layer included in the MEA was 54%. The comparative fuel cell 3 was subjected to the same evaluation test as that of Example 1 to obtain voltage retention rate. Table 1 shows the results.

### Comparative Example 4

A cathode catalyst layer was prepared in the same manner as in Example 5, and the cathode catalyst layer was compressed by hot pressing. Except for the use of this cathode catalyst layer, a comparative fuel cell 4 was produced in the same manner as in Example 1. The porosity of the cathode catalyst layer included in the MEA was 48%. The comparative fuel cell 4 was subjected to the same evaluation test as that of Example 1 to obtain voltage retention rate. Table 1 shows the results.

### Comparative Example 5

The cathode catalyst ink was applied onto a PTFE sheet in the same manner as in Example 1, and the ink was dried at 25° C. to form a cathode catalyst layer. Except for the use of this cathode catalyst layer, a comparative fuel cell 5 was produced in the same manner as in Example 1. The porosity of the cathode catalyst layer included in the MEA was 87%. The comparative fuel cell 5 was subjected to the same evaluation test as that of Example 1 to obtain voltage retention rate. Table 1 shows the results.

### Comparative Example 6

A cathode catalyst layer was prepared in the same manner as in Example 1, and the cathode catalyst layer was compressed by hot pressing. Except for the use of this cathode catalyst layer, a comparative fuel cell 6 was produced in the same manner as in Example 1. The porosity of the cathode catalyst layer included in the MEA was 48%. The comparative fuel cell 6 was subjected to the same evaluation test as that of Example 1 to obtain voltage retention rate. Table 1 shows the results.

Table 1 shows the weight ratio of the polymer electrolyte to the catalyst support in each cathode catalyst layer (weight ratio of polymer electrolyte), the porosity of the cathode catalyst layer (porosity), presence or absence of supply pumps, the cathode catalyst support (catalyst support), and the average voltage at the 1^{st} cycle (initial voltage). In Table 1, carbon black is abbreviated as CB, and carbon nanofibers are abbreviated as CNF.

TABLE 1

| | Weight ratio | | Presence or | | Initial | Voltage |
|---|---|---|---|---|---|---|
| | of polymer | Porosity | absence of | Catalyst | voltage | retention |
| | electrolyte | (%) | supply pump | support | (V) | rate (%) |
| Fuel cell 1 | 0.2 | 75 | Present | CB | 0.413 | 94 |
| Fuel cell 2 | 0.3 | 72 | Present | CB | 0.442 | 96 |
| Fuel cell 3 | 0.4 | 69 | Present | CB | 0.452 | 97 |
| Fuel cell 4 | 0.5 | 66 | Present | CB | 0.449 | 96 |
| Fuel cell 5 | 0.55 | 64 | Present | CB | 0.436 | 91 |
| Fuel cell 6 | 0.4 | 71 | Present | CNF | 0.412 | 93 |
| Fuel cell 7 | 0.2 | 50 | Present | CB | 0.428 | 84 |
| Fuel cell 8 | 0.2 | 85 | Present | CB | 0.397 | 90 |
| Fuel cell 9 | 0.4 | 69 | Absent | CB | 0.408 | 91 |
| Comparative | 0.15 | 77 | Present | CB | 0.320 | 82 |
| fuel cell 1 | | | | | | |
| Comparative | 0.6 | 62 | Present | CB | 0.414 | 47 |
| fuel cell 2 | | | | | | |
| Comparative | 1.0 | 54 | Present | CB | 0.410 | 23 |
| fuel cell 3 | | | | | | |
| Comparative | 0.55 | 48 | Present | CB | 0.419 | 41 |
| fuel cell 4 | | | | | | |
| Comparative | 0.2 | 87 | Present | CB | 0.333 | 85 |
| fuel cell 5 | | | | | | |
| Comparative | 0.2 | 48 | Present | CB | 0.429 | 50 |
| fuel cell 6 | | | | | | |

Fuel cells 1 to 9, in which the weight ratio of the polymer electrolyte to the catalyst support in the cathode catalyst layer (weight ratio of polymer electrolyte) was set to from 0.2 to 0.55 and the porosity of the cathode catalyst layer was set to 50% to 85%, exhibited good initial voltages and voltage retention rates (long-term life characteristic).

In particular, the fuel cells 1 to 6 and the fuel cells 8 and 9 exhibit high voltage retention rates, compared with the fuel cell 7, in which the porosity of the cathode catalyst layer was set to 50%. The voltage retention rate of the fuel cell 7 is slightly lower than those of the fuel cells of the other Examples, probably because the porosity of the cathode catalyst layer used in the fuel cell 7 is low. Thus, although the weight ratio of the polymer electrolyte is low, the swelling of the polymer electrolyte due to MCO has a large impact, thereby resulting in a slight decrease in oxidant diffusibility.

Also, the fuel cells 1 to 7 and the fuel cell 9 have high initial voltages, compared with the fuel cell 8, in which the porosity of the cathode catalyst layer was set to 85%. The initial voltage of the fuel cell 8 is slightly lower than those of the fuel cells of the other Examples, probably because the low polymer electrolyte content in the cathode catalyst layer resulted in a slight decrease in the proton conductivity of the cathode catalyst layer.

It should be noted, however, that the fuel cells 7 and 8 also have sufficiently good cell characteristics, compared with the comparative fuel cells.

In particular, the fuel cells 2 to 4, in which the weight ratio of polymer electrolyte was set to from 0.3 to 0.5, exhibit particularly good characteristics.

The above results indicate that the weight ratio of polymer electrolyte and the porosity of the cathode catalyst layer have a large impact on long-term life characteristics.

The voltage retention rate of the fuel cell 9 not using pumps for supplying air and fuel is significantly improved, compared with the comparative fuel cells 1 to 6. However, the initial voltage of the fuel cell 9 is slightly lower than those of the fuel cells 1 to 7. This is probably because the amount of supply of high concentration methanol aqueous solution to the anode and the amount of supply of oxidant to the cathode are not controlled in a sufficiently appropriate manner and the decrease in the oxidant diffusibility in the cathode due to MCO is not sufficiently suppressed.

On the other hand, the comparative fuel cells 1 to 3, in which the weight ratio of the polymer electrolyte to the catalyst support in the cathode catalyst layer is outside the range from 0.2 to 0.55, and the comparative fuel cells 4 to 6, in which the porosity of the cathode catalyst layer is outside the range of 50% to 85%, exhibited a significant deterioration in cell characteristics. That is, the results of the comparative fuel cells 1 to 3 indicate that even when the porosity of the cathode catalyst layer is in the range of 50 to 85%, if the weight ratio of polymer electrolyte in the cathode catalyst layer is not within the range from 0.2 to 0.55, the cell characteristics deteriorate significantly. Further, the results of the comparative fuel cells 4 to 6 indicate that even when the weight ratio of polymer electrolyte in the cathode catalyst layer is in the range from 0.2 to 0.55, if the porosity of the cathode catalyst layer is outside the range of 50 to 85%, the cell characteristics also deteriorate significantly.

Specifically, the comparative fuel cell 1 and the comparative fuel cell 5 exhibited a significant decrease particularly in initial voltage. In the comparative fuel cell 1, the amount of polymer electrolyte contained in the cathode catalyst layer is small. In the comparative fuel cell 5, the porosity of the cathode catalyst layer is too large. It is therefore not possible to ensure sufficient proton conductive paths in the cathode catalyst layer. This is believed to be the reason for the significantly low initial voltages of the comparative fuel cell 1 and the comparative fuel cell 5.

The comparative fuel cells 2 to 4 and the comparative fuel cell 6 exhibited a significant deterioration particularly in long-term life characteristic (voltage retention rate). In the comparative fuel cells 2 and 3, the amount of polymer electrolyte contained in the cathode catalyst layer is excessive. In the comparative fuel cell 4 and the comparative fuel cell 6, the porosity of the cathode catalyst layer is too small. Thus, the polymer electrolyte swells significantly due to MCO, and the porosity of the cathode catalyst layer decreases significantly, compared with the fuel cells 1 to 9. Therefore, in the comparative fuel cells 2 to 4 and the comparative fuel cell 6, the oxidant diffusibility in the cathode catalyst layer decreases significantly. This is believed to the reason for the significantly low long-term life characteristic.

The above results indicate that the invention can provide a direct methanol fuel cell with excellent long-term life characteristics.

The direct methanol fuel cell of the invention has excellent long-term life characteristics, thus being capable of supplying power stably throughout the service life. Therefore, the direct methanol fuel cell of the invention can be advantageously used as the power source for mobile devices such as cell phones and notebook personal computers, a portable general-purpose power source, etc.

Although the invention has been described in terms of the presently preferred embodiments, it is to be understood that such disclosure is not to be interpreted as limiting. Various alterations and modifications will no doubt become apparent to those skilled in the art to which the invention pertains, after having read the above disclosure. Accordingly, it is intended that the appended claims be interpreted as covering all alterations and modifications as fall within the true spirit and scope of the invention.

1. A direct methanol fuel cell using methanol or a methanol aqueous solution with a methanol concentration of 3 mol/L or more as the fuel, comprising at least one cell including a membrane electrode assembly, the membrane electrode assembly comprising an anode, a cathode, and a polymer electrolyte membrane disposed between the anode and the cathode,
wherein the cathode includes a cathode catalyst layer in contact with the polymer electrolyte membrane, and a cathode diffusion layer in contact with the cathode catalyst layer,
the cathode catalyst layer includes a cathode catalyst, a catalyst support on which the cathode catalyst is supported, and a polymer electrolyte,
the weight ratio of the polymer electrolyte to the catalyst support is from 0.2 to 0.55, and
the cathode catalyst layer in a dry state has a porosity of 50% to 85%.

2. The direct methanol fuel cell in accordance with claim 1, wherein the weight ratio of the polymer electrolyte to the catalyst support is from 0.3 to 0.5.

3. The direct methanol fuel cell in accordance with claim 1, wherein the cathode catalyst layer in a dry state has a porosity of 60% to 80%.

4. The direct methanol fuel cell in accordance with claim 1, wherein the catalyst support is a carbon material.

5. The direct methanol fuel cell in accordance with claim 1, further comprising a fuel tank, a fuel supply pump for supplying the fuel to the anode, and an oxidant supply pump for supplying an oxidant to the cathode, wherein the fuel tank contains the fuel.

6. The direct methanol fuel cell in accordance with claim 1, further comprising an anode current collector plate in contact with the anode, a cathode current collector plate in contact with the cathode, and a fuel tank for holding the fuel,
wherein the anode current collector plate and the cathode current collector plate each have a plurality of through-holes which penetrate through the thickness of the current collector plate,
the fuel tank is disposed on the other side of the anode current collector plate from the side in contact with the anode, and
the fuel contained in the fuel tank is supplied to the anode through the plurality of through-holes in the anode current collector plate.

7. The direct methanol fuel cell in accordance with claim 6, wherein an oxidant is supplied to the cathode through the plurality of through-holes in the cathode current collector plate.

8. The direct methanol fuel cell in accordance with claim 1, wherein the catalyst support is carbon black.

9. The direct methanol fuel cell in accordance with claim 1, wherein the catalyst support is carbon nanofibers.

10. The direct methanol fuel cell in accordance with claim 1, wherein the cathode catalyst is Pt, and the catalyst support is carbon black.

11. The direct methanol fuel cell in accordance with claim 1, wherein the cathode catalyst is Pt, and the catalyst support is carbon nanofibers.

12. The direct methanol fuel cell in accordance with claim 1, wherein the amount of the polymer electrolyte contained in the cathode catalyst layer is 0.1 to 1 mg/cm².
